(19) United States
(12) Patent Application Publication
(10) Pub. No.: US 2024/0412315 A1
(43) Pub. Date: Dec. 12, 2024

(54) SYSTEM FOR HIGH INTEGRITY REAL TIME PROCESSING OF DIGITAL FORENSICS DATA

(71) Applicant: BANK OF AMERICA CORPORATION, Charlotte, NC (US)

(72) Inventors: James Brian Chilton, Cornelius, NC (US); David Scott Strubbe, Waxhaw, NC (US); James Oran Ray, Frisco, TX (US); Cameron Cody Boyles, Charlotte, NC (US); George Anthony Albero, Charlotte, NC (US)

(73) Assignee: BANK OF AMERICA CORPORATION, Charlotte, NC (US)

(21) Appl. No.: 18/207,394

(22) Filed: Jun. 8, 2023

(51) Int. Cl. G06Q 50/26

(52) U.S. Cl. CPC G06Q 50/26

(57) ABSTRACT

A system is provided for high integrity real time processing of digital forensics data. In particular, the system may comprise a distributed electronic data register that may be hosted on a plurality of distributed servers. The distributed register may store digital forensics data within a secure data record within the distributed register. In this regard, entities or individuals who are authorized to access and/or receive the evidence may submit a digital signature to the distributed register. The system may further comprise an artificial intelligence engine that may use machine learning to identify potential anomalies in real time within the chain of evidence and trigger an alert service to transmit real time alerts to one or more systems and/or users. In this way, the system provides a more secure and efficient way to store, process, and manage digital forensics data.

### TECHNOLOGICAL FIELD

Example embodiments of the present disclosure relate to a system and method for high integrity real time processing of digital forensics data.

### BACKGROUND

There is a need for a way to securely process and manage digital forensics data.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for high integrity real time processing of digital forensics data. In particular, the system may comprise a distributed electronic data register that may be hosted on a plurality of distributed servers. The distributed register may store digital forensics data (e.g., data regarding physical or virtual resources, such as evidence) within a secure data record within the distributed register. In this regard, entities or individuals who are authorized to access and/or receive the evidence may submit a digital signature to the distributed register (e.g., by signing a data record using a cryptographic private key associated with the authorized entity or individual). By appending each interactions with the evidence over time, the distributed register may contain an authentic, high integrity history of the evidence starting from the point of capture onwards. The system may further comprise an artificial intelligence engine that may use machine learning to identify potential anomalies in real time within the chain of evidence and trigger an alert service to transmit real time alerts to one or more systems and/or users. In this way, the system provides a more secure and efficient way to store, process, and manage digital forensics data.

Accordingly, embodiments of the present disclosure provide a system for high integrity real time processing of digital forensics data, the system comprising a processing device; a non-transitory storage device containing instructions when executed by the processing device, causes the processing device to perform the steps of receiving, from a user computing device, an origination data record comprising forensic data associated with origination of a resource, wherein the origination data record is digitally signed using a cryptographic private key associated with a first user; continuously receiving location information from a transmitter associated with the resource; receiving, from the user computing device, an event data record comprising event-related data associated with the resource; appending the origination data record, the location information, and the event data record to a distributed data register; based on analyzing, using an artificial intelligence engine, the origination data record, the location information, and the event data record, identifying one or more anomalies associated with the resource; and transmitting an alert to one or more computing devices, the alert comprising information about the one or more anomalies associated with the resource.

In some embodiments, the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

In some embodiments, identifying the one or more anomalies comprises executing an integrity validation check on the digital evidence, wherein the integrity validation check comprises generating a validation hash output of the digital evidence; comparing the validation hash output with the hash output of the digital evidence stored within the origination data record; and based on detecting a mismatch between the validation hash output and the hash output stored within the origination data record, determining that the digital evidence has been corrupted.

In some embodiments, the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

In some embodiments, the event data record comprises an indication that the resource is being transferred to a second user, wherein the event data record is digitally signed using the cryptographic key associated with the first user, wherein the instructions further cause the processing device to perform the step of receiving a second event data record indicating receipt of the resource by the second user, wherein the second event data record is digitally signed using a cryptographic private key associated with the second user.

In some embodiments, the one or more anomalies associated with the resource comprise at least one of unauthorized movement or access to the resource, missing or corrupt elements of the resource, or a gap in a chain of custody associated with the resource.

In some embodiments, the artificial intelligence engine is trained using supervised learning based on historical data associated with the resource and stored on the distributed register.

Embodiments of the present disclosure also provide a computer program product for high integrity real time processing of digital forensics data, the computer program product comprising a non-transitory computer-readable medium comprising code causing an apparatus to perform the steps of receiving, from a user computing device, an origination data record comprising forensic data associated with origination of a resource, wherein the origination data record is digitally signed using a cryptographic private key associated with a first user; continuously receiving location information from a transmitter associated with the resource; receiving, from the user computing device, an event data record comprising event-related data associated with the resource; appending the origination data record, the location information, and the event data record to a distributed data register; based on analyzing, using an artificial intelligence engine, the origination data record, the location information, and the event data record, identifying one or more anomalies associated with the resource; and transmitting an alert to one or more computing devices, the alert comprising information about the one or more anomalies associated with the resource.

In some embodiments, the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

In some embodiments, identifying the one or more anomalies comprises executing an integrity validation check on the digital evidence, wherein the integrity validation check comprises generating a validation hash output of the digital evidence; comparing the validation hash output with the hash output of the digital evidence stored within the origination data record; and based on detecting a mismatch between the validation hash output and the hash output stored within the origination data record, determining that the digital evidence has been corrupted.

In some embodiments, the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

In some embodiments, the event data record comprises an indication that the resource is being transferred to a second user, wherein the event data record is digitally signed using the cryptographic key associated with the first user, wherein the non-transitory computer-readable medium further comprises code causing the apparatus to perform the step of receiving a second event data record indicating receipt of the resource by the second user, wherein the second event data record is digitally signed using a cryptographic private key associated with the second user.

In some embodiments, the one or more anomalies associated with the resource comprise at least one of unauthorized movement or access to the resource, missing or corrupt elements of the resource, or a gap in a chain of custody associated with the resource.

Embodiments of the present disclosure also provide a computer-implemented method for high integrity real time processing of digital forensics data, the computer-implemented method comprising receiving, from a user computing device, an origination data record comprising forensic data associated with origination of a resource, wherein the origination data record is digitally signed using a cryptographic private key associated with a first user; continuously receiving location information from a transmitter associated with the resource; receiving, from the user computing device, an event data record comprising event-related data associated with the resource; appending the origination data record, the location information, and the event data record to a distributed data register; based on analyzing, using an artificial intelligence engine, the origination data record, the location information, and the event data record, identifying one or more anomalies associated with the resource; and transmitting an alert to one or more computing devices, the alert comprising information about the one or more anomalies associated with the resource.

In some embodiments, the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

In some embodiments, identifying the one or more anomalies comprises executing an integrity validation check on the digital evidence, wherein the integrity validation check comprises generating a validation hash output of the digital evidence; comparing the validation hash output with the hash output of the digital evidence stored within the origination data record; and based on detecting a mismatch between the validation hash output and the hash output stored within the origination data record, determining that the digital evidence has been corrupted.

In some embodiments, the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

In some embodiments, the event data record comprises an indication that the resource is being transferred to a second user, wherein the event data record is digitally signed using the cryptographic key associated with the first user, wherein the computer-implemented method further comprises receiving a second event data record indicating receipt of the resource by the second user, wherein the second event data record is digitally signed using a cryptographic private key associated with the second user.

In some embodiments, the one or more anomalies associated with the resource comprise at least one of unauthorized movement or access to the resource, missing or corrupt elements of the resource, or a gap in a chain of custody associated with the resource.

In some embodiments, the artificial intelligence engine is trained using supervised learning based on historical data associated with the resource and stored on the distributed register.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for high integrity real time processing of digital forensics data, in accordance with an embodiment of the disclosure;

FIG. 2A illustrates an exemplary DLT architecture, in accordance with an embodiment of the disclosure;

FIG. 2B illustrates an exemplary transaction object within the DLT architecture, in accordance with an embodiment of the disclosure;

FIG. 3A illustrates an exemplary process of creating an NFT 300, in accordance with an embodiment of the disclosure;

FIG. 3B illustrates an exemplary NFT as a multi-layered documentation of a resource, in accordance with an embodiment of the disclosure; and

FIG. 4 illustrates a method for high integrity real time processing of digital forensics data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like. In yet other embodiments, the resources may include real-world goods or commodities that may be acquired and/or exchanged by a user.

“Cryptographic hash function” or “hash algorithm” as used herein may refer to a set of logical and/or mathematical operations or processes that may be executed on a specified segment of data to produce a hash output. Given a specified data input, the hash algorithm may produce a cryptographic hash output value which is a fixed-length character string. Examples of such hash algorithms may include MD5, Secure Hash Algorithm/SHA, or the like. According, “hashing” or “hashed” as used herein may refer to the process of producing a hash output based on a data input into a hash algorithm.

“Public-key cryptography” or “asymmetric cryptography” may refer to a process for data encryption and/or verification by which a pair of asymmetric corresponding cryptographic keys are generated (e.g., a “key pair” comprising a “public key” intended to be distributed and a “private key” intended to be possessed by a single user or device). Data encrypted using a public key may be decrypted only by the possessor of the corresponding private key. Furthermore, data signed with a private key may be validated by the possessor of the corresponding public key to verify the identity of the signer (which may be referred to herein as “digital signing”).

“Forensics data” as used herein may refer to any type of data or metadata that relates to tracking a status and/or change in status of a resource, where the resource may be physical, virtual, digital, and/or the like. For instance, in some embodiments, the resource may include physical or digital evidence that may be tracked by the system from the point of its origination and collection and throughout the chain of custody as it is accessed, transferred, stored, and/or the like.

Securely collecting, transporting, and/or storing evidence, particularly digital evidence, poses a number of technological challenges. For instance, any gaps in the life cycle of the evidence as the evidence is passed along the chain of custody or any signs that the evidence has been subject to unauthorized modification or access may severely impact or damage the confidence in the authenticity of such evidence. Furthermore, digital evidence in particular poses a number of challenges. Due its nature, digital evidence is especially susceptible to being accessed by unauthorized parties, becoming corrupted and/or irrecoverable from storage, and/or the like. Accordingly, there is a need for a more secure way to collect, manage, and/or store such evidence.

To address the above concerns among others, the system described herein provides a way to perform high integrity real time processing of digital forensics data. The system may comprise a distributed register (or a distributed ledger) that may be hosted on a plurality of distributed servers (which may be referred to herein as “nodes” or “distributed register nodes”). The distributed register may store forensics data regarding resources (e.g., physical or digital evidence) from the point of collection or origination and onwards. In this regard, a data record may be submitted to the distributed register whenever an item of evidence is collected or originated, where the data record may contain a unique identifier associated with the item of evidence (e.g., an alphanumeric character string such as a hash value). In some embodiments, the data record may take the form of a non-fungible token stored on the distributed register that uniquely identifies the evidence.

In cases where the evidence is physical evidence (e.g., a portable storage device such as a hard drive or memory card), a location tracker may be affixed to the physical evidence or a container for the physical evidence (e.g., an evidence bag), where the location tracker may transmit the location (e.g., coordinates, physical addresses, location within a building, and/or the like) of the physical evidence continuously at designated intervals. Examples of location trackers may include radio frequency (“RF”) trackers, global positioning system (“GPS”) trackers, ultra-wideband (“UWB”) trackers, cellular network based trackers, and/or the like. When the evidence is collected (e.g., by one or more authorized users), and the transmitter is activated and secured to the evidence, the transmitter may be configured to transmit a new data record to the distributed register, where the data record comprises data and/or metadata associated with the physical evidence. Such data and/or metadata may include, for instance, a description of the evidence and/or its contents, a timestamp for when the evidence was secured and collected, a location from which the evidence originated and/or was collected, the identity of the one or more authorized users who collected the evidence, and/or the like. In some embodiments, the one or more authorized users may interface with the transmitter through a user device (e.g., a smartphone or other computing device) to input the relevant information regarding the evidence into the data record.

In cases where the evidence is virtual or digital evidence (e.g., a media file such as an image, video, and/or audio file, a document file, and/or the like), a data record may be generated that includes various types of information about the digital evidence. Such information may include a unique identifier associated with the digital evidence, cryptographic hash output of the digital evidence, media metadata, imaging processes and/or settings used to capture the digital evidence, timestamps and location data at which the digital evidence was collected, IP addresses associated with the device that captured and/or stored the digital evidence, and/or the like. As is the case with physical evidence, a data record associated with digital evidence may take the form of a non-fungible token stored on the distributed register that uniquely identifies the digital evidence. The data record may then be transmitted to the distributed register.

The system may in some embodiments require the one or more authorized users (e.g., an investigator, evidence collector, and/or the like) to digitally sign the data record containing information about the evidence. In this regard, the authorized user may interact with a computing device (e.g., the user device) to provide authentication credentials associated with the authorized user to the system for verification. For instance, the user device may prompt the user to provide one or more authentication credentials such as a username and password, PIN, multi-factor authentication (“MFA”) token, unique characteristic data (e.g., a fingerprint scan, voice sample, iris scan, and/or the like), and/or the like. Upon receiving the credentials from the authorized user and verifying the identity of the authorized user, user device may digitally sign the data record using a private cryptographic key associated with the authorized user and transmit the data record to be appended to the distributed register.

The system may continuously monitor the status of the evidence over time, and be configured to detect changes in the status, such as when the evidence moves or is copied from one location to another, when the evidence is accessed or possessed by new users, and/or the like. In this regard, the system may submit a new data record to the distributed register each time the evidence is accessed or received by a new user, and may further require that such new users digitally sign the new data record indicating access or receipt of the evidence. In some embodiments, the system may further submit update data records that contain an update regarding the status of the evidence, even if the update indicates that the evidence has not changed locations (e.g., the evidence is stationary). For instance, in embodiments in which the evidence is physical evidence, the system may periodically submit data records containing the tracker-based location of the physical evidence even if the physical evidence has not moved from its original location.

Authorized users may submit data records on demand with updates on the status of a piece of evidence and/or each time the authorized user accesses the evidence. In this regard, an investigator may submit a data record indicating that the investigator is accessing the item of evidence for the purpose of analyzing the evidence and/or preparing a report. In such an embodiment, the data record may contain information such as a timestamp for when the analysis has begun (e.g., an evidence “checkout” time), the previous location of the evidence, the current location of the evidence, the identity of the entity who currently has possession of the evidence and/or is accessing the evidence, and/or the like. Once the user has finished analyzing the evidence, the user may submit another data record indicating that the analysis is complete. In such a scenario, the data record may include a timestamp for when the analysis was completed (e.g., an evidence “checkin” time), a summary of the analysis, the analysis itself or a link to the analysis hosted on another server or device, and/or the like. Each time that an authorized user submits a data record, the system may require the user to digitally sign the data record as described above. In some embodiments, the system may further be configured to allow users to submit data records with respect to a detected change in status of the evidence. For instance, if an investigator or administrator notices that an article of physical evidence shows signs of tampering (e.g., the lock securing the evidence has been opened) or the physical evidence has gone missing, the user may submit a data record to the distributed register, where the data record includes information such as a timestamp for when the change was first detected, the last known location of the evidence, a description of the abnormality, and/or the like.

In embodiments in which the evidence is digital evidence, the system may periodically (or alternatively on demand) perform integrity validation checks on the evidence based on the hash values stored within the distributed register. For example, if the evidence is a digital photograph, the system may input the photograph into a hash algorithm (e.g., the same hash algorithm that was used to generate the original hash value for the digital evidence) to provide a validation hash output associated with the digital evidence. Such a validation hash output may then be compared against the hash value associated with the digital evidence within the distributed register. If a mismatch is detected, the system may determine that the evidence has been modified (e.g., tampered with or degraded from storage corruption). In this way, the distributed register may serve as a durable, high-fidelity, and complete record of the entire chain of custody of each piece of evidence registered in the system.

The system may further comprise an artificial intelligence (“AI”) engine that may continuously analyze the information stored within the distributed register. In this regard, the AI engine may be configured to identify, through machine learning, one or more anomalies in the forensics data with respect to a particular piece of evidence. Examples of such anomalies may include abnormal turnaround times for investigator analysis (e.g., a user has accessed a piece of evidence for a longer time period than normal), missing or corrupted elements of the evidence, unauthorized copying or movement of the evidence, unauthorized access to the evidence (or otherwise unusual but authorized access to the evidence), storage in unauthorized locations and/or devices, and/or the like.

The AI engine may be trained through supervised training based on selected historical information regarding the life cycles of evidence within the distributed register. In this regard, one or more authorized users may select and input the training data into the machine learning model based on quality assurance (“QA”) processes and/or case reviews. In some embodiments, the machine learning model itself may be stored in the distributed register. The system may then be configured to continuously monitor and detect the presence of one or more anomalies in the forensics data through unsupervised learning. If an anomaly is detected within the forensics data in the distributed register, an automated alert engine may be configured to generate, in real time or near real time, one or more alerts and transmit the alerts to one or more users (e.g., administrators, investigators, and/or the like). In this regard, the alerts may contain information such as a description of the evidence and the nature of the anomalies, the last known location of the evidence, the identity of the users who have accessed and/or had custody of the evidence, comparisons to “normal” evidence life cycles for the evidence type, and/or the like. In this way, the system may provide a secure way to process and manage forensics data.

An exemplary embodiment is described below for illustrative purposes only and should not be construed as restricting the scope of the disclosure provided herein. In one embodiment, a user such as an investigator may arrive on site to collect physical evidence (e.g., a laptop) as well as digital evidence (e.g., one or more digital images of the scene as discovered). The user may provide one or more authentication credentials (e.g., unique characteristic data, a username and password, MFA token, and/or the like) to a user device such as a smartphone. Once the user has been authenticated, the user may generate a data record associated with each piece of evidence collected. For physical evidence, a transmitter may be affixed to the physical evidence and/or a container for the physical evidence (e.g., an evidence bag), whereas for digital evidence, the device used to capture the digital evidence (e.g., a digital camera) may be pre-equipped with a location transmitter. The data records may be digitally signed by the user using a cryptographic private key associated with the user. Such data records may serve as the “origins” of each piece of evidence and may contain various types of information about the evidence as described elsewhere herein.

As the user transports the evidence (e.g., to a storage facility), the transmitters associated with the various types of evidence may periodically transmit location data to the system, which may then store the location of each piece of evidence within data records within the distributed register. Once the investigator relinquishes possession of the evidence to another, second user (e.g., an administrator for an evidence lockup), the second user may then submit a data record indicating receipt of the evidence to the distributed register. Said data record may be digitally signed by the second user using a cryptographic private key associated with the second user. Each time that a piece of evidence is moved, accessed, or is stationary, data records may be transmitted to the distributed register to update the status of the evidence.

Subsequently, the AI engine may detect an anomaly within the forensics data with respect to a particular piece of evidence. For instance, the AI engine may detect a gap in the chain of custody for the laptop (e.g., the transmitter has failed to provide a location for the laptop). In such an embodiment, the AI engine may recognize the anomaly using the machine learning models described above and subsequently transmit an alert to one or more users (e.g., an administrator, investigator, and/or the like) regarding the anomaly.

The system as described herein provides a number of technological benefits over conventional systems for processing forensics data. In particular, by storing and monitoring forensics data within a distributed register, the replicated data structure of the distributed register makes the forensics data highly resilience against data corruption and/or tampering. Furthermore, by using machine learning models to detect and transmit alerts regarding anomalies in real time, the system provides a way for authorized users to rapidly respond to events that may threaten the integrity or authenticity of the evidence collected.

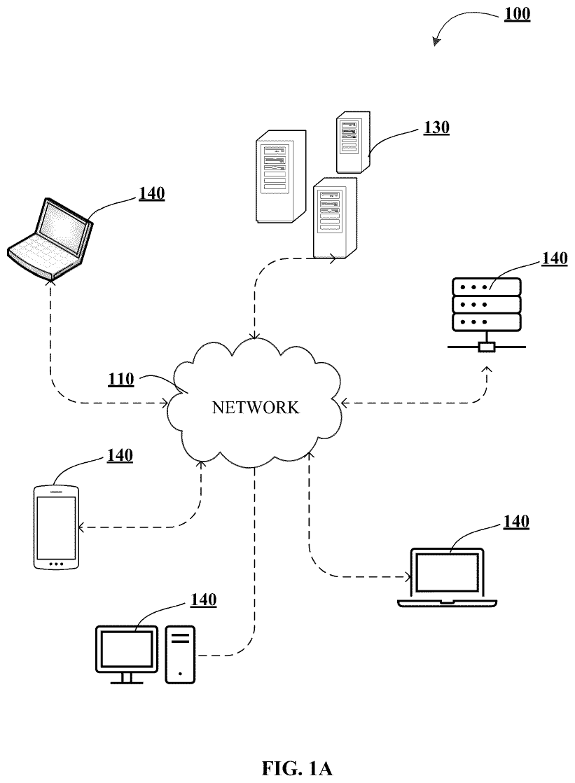

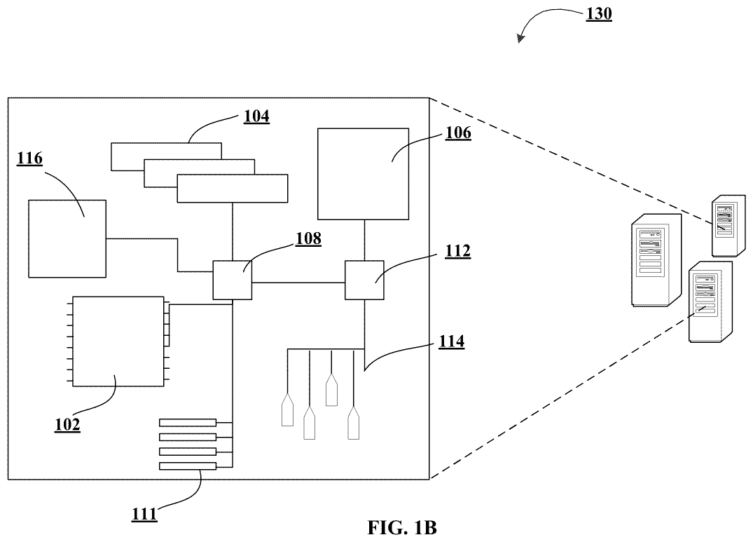

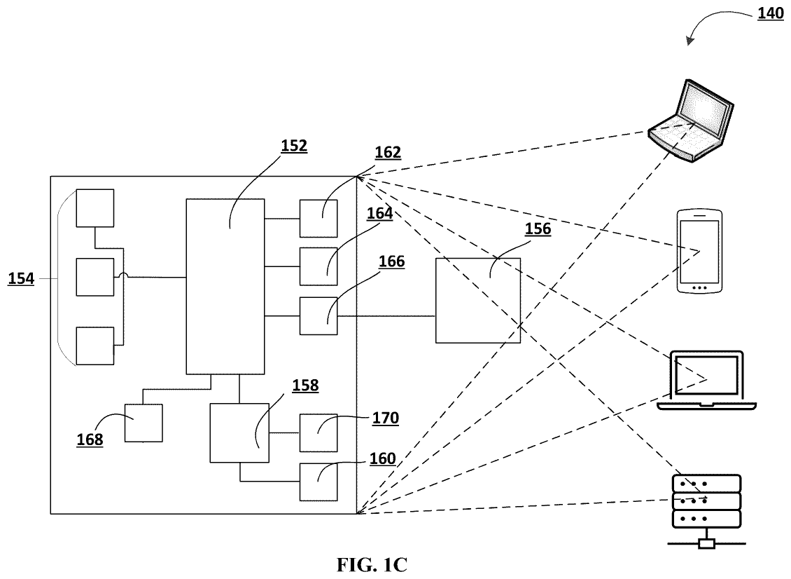

FIGS. 1A-1C illustrate technical components of an exemplary distributed computing environment 100 for the system for high integrity real time processing of digital forensics data. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

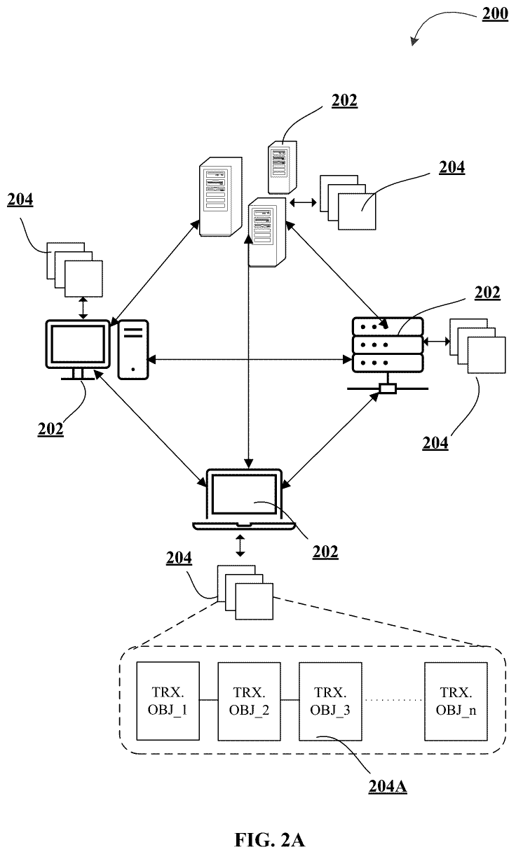

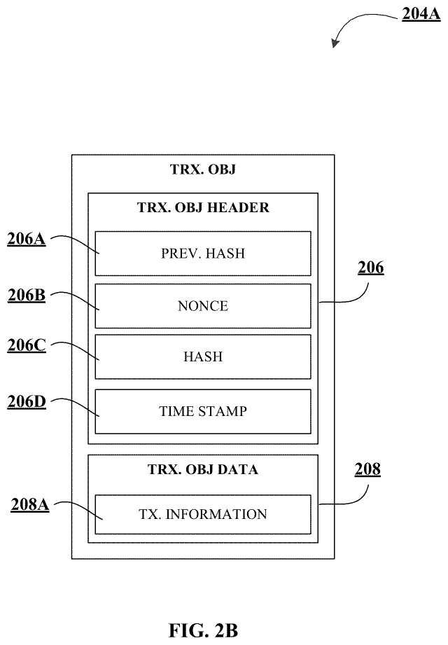

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

An NFT is a cryptographic record (referred to as “tokens”) linked to a resource. An NFT is typically stored on a distributed ledger that certifies ownership and authenticity of the resource, and exchangeable in a peer-to-peer network.

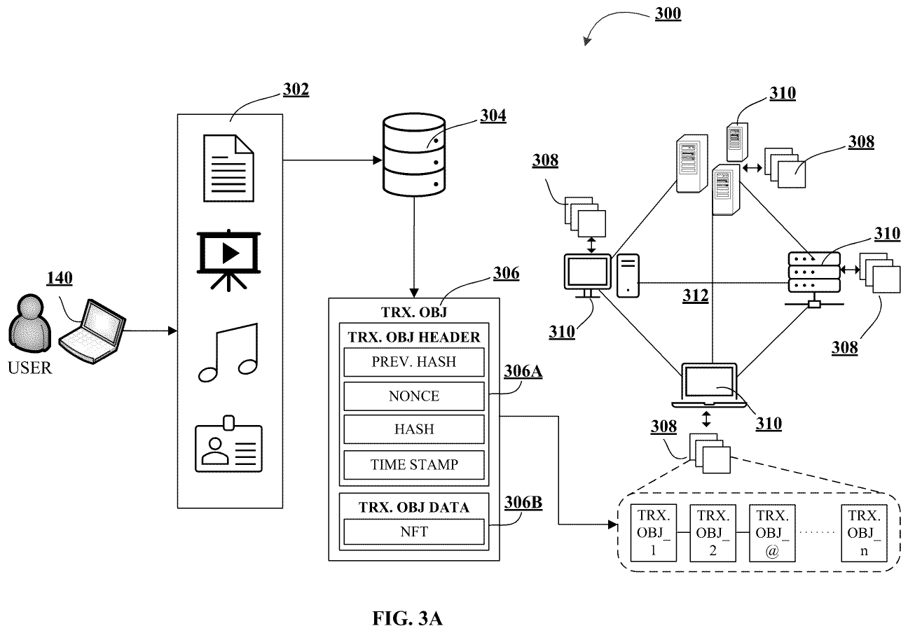

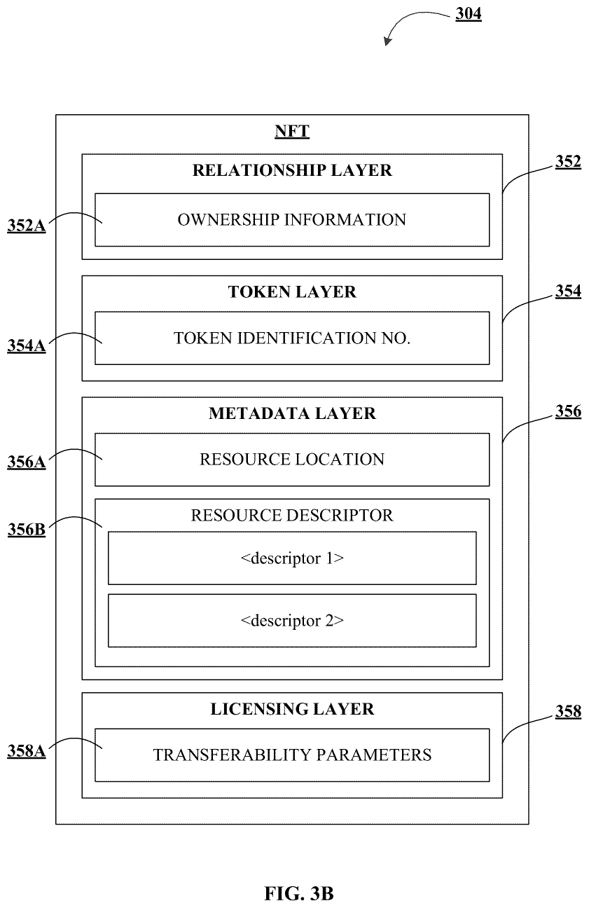

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, virtual world items, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce—a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. The transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process.

As shown in FIG. 3A, the distributed ledger 308 may be maintained on multiple devices (nodes) 310 that are authorized to keep track of the distributed ledger 308. For example, these nodes 310 may be computing devices such as system 130 and end-point device(s) 140. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S1, the relationship between B1 and S1 as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

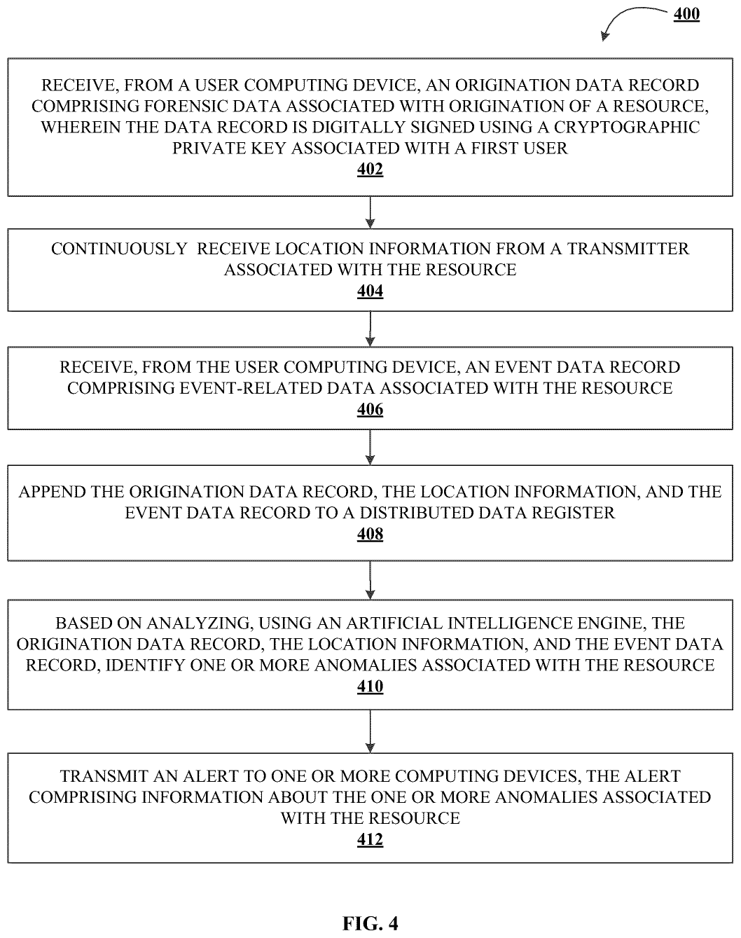

FIG. 4 illustrates a method 400 for high integrity real time processing of digital forensics data, in accordance with an embodiment of the disclosure. As shown in block 402, the method includes receiving, from a user computing device, an origination data record comprising forensic data associated with origination of a resource, wherein the data record is digitally signed using a cryptographic private key associated with a first user. In some embodiments, the resource may be an article of evidence (e.g., physical or digital evidence). Accordingly, the origination data record may include various types of information regarding the origination of the evidence (e.g., when the evidence was collected, captured, or generated). In embodiments in which the evidence is physical evidence, the data record may contain information such as location information regarding where the evidence was collected, a description of the evidence, a timestamp for when the evidence was collected, identifying information regarding users or parties who collected the evidence, and/or the like. In embodiments in which the evidence is digital evidence, the data record may comprise information such as a hash output of the digital evidence, settings used to create the digital evidence, a timestamp for creation of the digital evidence, identifying information regarding the device used to capture and/or store the digital evidence, location information, IP address information for the device used to capture and/or store the digital evidence, and/or the like.

In some embodiments, the data record may be digitally signed in response to the first user (e.g., an investigator) providing authentication credentials associated with the first user (e.g., unique characteristic information such as fingerprint data, a username and password, one-time password or “OTP,” MFA token, and/or the like). Accordingly, signing the data record using the private key associated with the first user provides a unique identifier regarding the source of the data record.

Next, as shown in block 404, the method includes continuously receiving location information from a transmitter associated with the resource. In embodiments in which the resource is physical evidence, the transmitter may be an RF transmitter, GPS transmitter, UWB transmitter, and/or the like which may be operatively coupled to the physical evidence. In embodiments in which the resource is digital evidence, the transmitter may be a network interface of the device on which the digital evidence is stored. The transmitter may be configured to transmit location information at regular predefined intervals (e.g., every 15 minutes, every hour, every day, and/or the like) and/or in response to a triggering of an event associated with the resource.

Next, as shown in block 406, the method includes receiving, from the user computing device, an event data record comprising event-related data associated with the resource. An event data record may be received by the system, for instance, when a change in the status of the resource is triggered by a particular event. For instance, the event may include the evidence being transported, the evidence being modified or accessed, a change in of ownership or possession of the evidence (e.g., possessed by second user), and/or the like. Each event data record may be digitally signed using a cryptographic private key associated with the user who possesses the evidence and/or is designated to be an administrator or custodian of the evidence. In this regard, the event data record may indicate that the resource was transferred from a first user to a second user. In such cases, the event data record may be digitally signed using a cryptographic private key associated with the first user. In response, a second event data record may be received that has been signed by a cryptographic private key associated with the second user, where the second event data record indicates that the second user has received the resource.

Next, as shown in block 408, the method includes appending the origination data record, the location information, and the event data record to a distributed data register. In particular, the origination data record may serve as the origin block with respect to a particular article of evidence. In some embodiments, the origination data record may take the form of a non-fungible token that uniquely represents the article of evidence. Each of the subsequent data records (e.g., location information, event data record, alert data records, and/or the like) may be appended to the origination data record as described above. In this way, the chain of data records may make up a durable history of all events associated with the life cycle of a particular piece of evidence.

Next, as shown in block 410, the method includes based on analyzing, using an artificial intelligence engine, the origination data record, the location information, and the event data record, identifying one or more anomalies associated with the resource. In this regard, the artificial intelligence engine may be trained using supervised learning based on selected historical data from the distributed register. The artificial intelligence engine may further be configured to identify the one or more anomalies through unsupervised learning based on event data records associated with historical anomalies. Examples of such anomalies may include gaps in a chain of custody for the evidence, abnormal turnaround times for analysis, missing or corrupted elements of the evidence, unauthorized movement or access to the evidence, and/or the like. Upon detecting the anomaly, the system may append an anomaly data record to the distributed register, where the anomaly data record may comprise information such as an identifier and/or classification of the anomaly, a description of the anomaly, the evidence affected by the anomaly, a timestamp for when the anomaly was detected, and/or the like.

In embodiments in which the evidence is digital evidence, identifying the one or more anomalies may comprise executing an integrity validation check on the digital evidence, comprising generating a validation hash on the digital evidence and comparing the validation hash to the hash value stored within the origination data record. If a mismatch is detected, the system may determine that the digital evidence has been corrupted and classify the corruption as an anomaly with respect to the evidence.

Next, as shown in block 412, the method includes transmitting an alert to one or more computing devices, the alert comprising information about the one or more anomalies associated with the resource. The information in the alert may comprise the information found in the anomaly data record appended to the distributed register. In this regard, the information may include an identifier and/or classification of the anomaly, a description of the anomaly, the evidence affected by the anomaly, a timestamp for when the anomaly was detected, and/or the like. The alerts may be transmitted to one or more users or entities associated with the evidence, such as the original collector of the evidence, custodians of the evidence, external or internal regulators of the evidence, and/or the like. The alerts may be transmitted to the users in real time or near real time. In this way, the system may ensure that remediation actions (e.g., securing the evidence, correcting faulty data records, mitigating damage to the evidence, and/or the like) may be carried out expediently after the discovery of the anomalies. Furthermore, by maintaining a complete record of the history of the evidence on the distributed register, the machine learning model of the AI engine may progressively become more accurate at identifying such anomalies.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for high integrity real time processing of digital forensics data, the system comprising:
a processing device;
a non-transitory storage device containing instructions when executed by the processing device, causes the processing device to perform the steps of:
receiving, from a user computing device, an origination data record comprising forensic data associated with origination of a resource, wherein the origination data record is digitally signed using a cryptographic private key associated with a first user;
continuously receiving location information from a transmitter associated with the resource;
receiving, from the user computing device, an event data record comprising event-related data associated with the resource;
appending the origination data record, the location information, and the event data record to a distributed data register;
based on analyzing, using an artificial intelligence engine, the origination data record, the location information, and the event data record, identifying one or more anomalies associated with the resource; and
transmitting an alert to one or more computing devices, the alert comprising information about the one or more anomalies associated with the resource.

2. The system of claim 1, wherein the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

3. The system of claim 2, wherein identifying the one or more anomalies comprises executing an integrity validation check on the digital evidence, wherein the integrity validation check comprises:
generating a validation hash output of the digital evidence;
comparing the validation hash output with the hash output of the digital evidence stored within the origination data record;
based on detecting a mismatch between the validation hash output and the hash output stored within the origination data record, determining that the digital evidence has been corrupted.

4. The system of claim 1, wherein the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

5. The system of claim 1, wherein the event data record comprises an indication that the resource is being transferred to a second user, wherein the event data record is digitally signed using the cryptographic key associated with the first user, wherein the instructions further cause the processing device to perform the step of receiving a second event data record indicating receipt of the resource by the second user, wherein the second event data record is digitally signed using a cryptographic private key associated with the second user.

6. The system of claim 1, wherein the one or more anomalies associated with the resource comprise at least one of unauthorized movement or access to the resource, missing or corrupt elements of the resource, or a gap in a chain of custody associated with the resource.

7. The system of claim 1, wherein the artificial intelligence engine is trained using supervised learning based on historical data associated with the resource and stored on the distributed register.

8. A computer program product for high integrity real time processing of digital forensics data, the computer program product comprising a non-transitory computer-readable medium comprising code causing an apparatus to perform the steps of:
receiving, from a user computing device, an origination data record comprising forensic data associated with origination of a resource, wherein the origination data record is digitally signed using a cryptographic private key associated with a first user;
continuously receiving location information from a transmitter associated with the resource;
receiving, from the user computing device, an event data record comprising event-related data associated with the resource;
appending the origination data record, the location information, and the event data record to a distributed data register;
based on analyzing, using an artificial intelligence engine, the origination data record, the location information, and the event data record, identifying one or more anomalies associated with the resource; and
transmitting an alert to one or more computing devices, the alert comprising information about the one or more anomalies associated with the resource.

9. The computer program product of claim 8, wherein the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

10. The computer program product of claim 9, wherein identifying the one or more anomalies comprises executing an integrity validation check on the digital evidence, wherein the integrity validation check comprises:
generating a validation hash output of the digital evidence;
comparing the validation hash output with the hash output of the digital evidence stored within the origination data record;
based on detecting a mismatch between the validation hash output and the hash output stored within the origination data record, determining that the digital evidence has been corrupted.

11. The computer program product of claim 8, wherein the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

12. The computer program product of claim 8, wherein the event data record comprises an indication that the resource is being transferred to a second user, wherein the event data record is digitally signed using the cryptographic key associated with the first user, wherein the non-transitory computer-readable medium further comprises code causing the apparatus to perform the step of receiving a second event data record indicating receipt of the resource by the second user, wherein the second event data record is digitally signed using a cryptographic private key associated with the second user.

13. The computer program product of claim 8, wherein the one or more anomalies associated with the resource comprise at least one of unauthorized movement or access to the resource, missing or corrupt elements of the resource, or a gap in a chain of custody associated with the resource.

14. A computer-implemented method for high integrity real time processing of digital forensics data, the computer-implemented method comprising:
receiving, from a user computing device, an origination data record comprising forensic data associated with origination of a resource, wherein the origination data record is digitally signed using a cryptographic private key associated with a first user;
continuously receiving location information from a transmitter associated with the resource;
receiving, from the user computing device, an event data record comprising event-related data associated with the resource;
appending the origination data record, the location information, and the event data record to a distributed data register;
based on analyzing, using an artificial intelligence engine, the origination data record, the location information, and the event data record, identifying one or more anomalies associated with the resource; and
transmitting an alert to one or more computing devices, the alert comprising information about the one or more anomalies associated with the resource.

15. The computer-implemented method of claim 14, wherein the resource is an article of digital evidence, wherein the transmitter is a wireless communication interface of a device that hosts the digital evidence, wherein the origination data record comprises location information regarding where the digital evidence was created, a timestamp for creation of the digital evidence, hash output of the digital evidence, and settings used to create the digital evidence.

16. The computer-implemented method of claim 15, wherein identifying the one or more anomalies comprises executing an integrity validation check on the digital evidence, wherein the integrity validation check comprises:
generating a validation hash output of the digital evidence;
comparing the validation hash output with the hash output of the digital evidence stored within the origination data record;
based on detecting a mismatch between the validation hash output and the hash output stored within the origination data record, determining that the digital evidence has been corrupted.

17. The computer-implemented method of claim 14, wherein the resource is an article of physical evidence, wherein the transmitter is at least one of a radio frequency (“RF”) transmitter, a global positioning system (“GPS”) transmitter, or an ultra-wide band (“UWB”) transmitter, wherein the origination data record comprises location information regarding where the physical evidence was collected, a timestamp for when the physical evidence was collected, a description of the physical evidence, and identifying information regarding the first user.

18. The computer-implemented method of claim 14, wherein the event data record comprises an indication that the resource is being transferred to a second user, wherein the event data record is digitally signed using the cryptographic key associated with the first user, wherein the computer-implemented method further comprises receiving a second event data record indicating receipt of the resource by the second user, wherein the second event data record is digitally signed using a cryptographic private key associated with the second user.

19. The computer-implemented method of claim 14, wherein the one or more anomalies associated with the resource comprise at least one of unauthorized movement or access to the resource, missing or corrupt elements of the resource, or a gap in a chain of custody associated with the resource.

20. The computer-implemented method of claim 14, wherein the artificial intelligence engine is trained using supervised learning based on historical data associated with the resource and stored on the distributed register.
